(19) United States
(12) Patent Application Publication
(10) Pub. No.: US 2004/0235677 A1
(43) Pub. Date: Nov. 25, 2004

(54) Methods and compositions for stabilizing swelling clays or migrating fines in formations

(76) Inventors: Philip D. Nguyen, Duncan, OK (US); Gregory D. Sutton, Pearland, TX (US); Thomas E. Rush, Richmond, TX (US)

Correspondence Address: Robert A. Kent, Halliburton Energy Services, 2600 South 2nd Street, Duncan, OK, 73536, US

(21) Appl. No.: 10/444,426

(22) Filed: May 23, 2003

(51) Int. Cl. C09K 7/02

(52) U.S. Cl. 507/200

(57) ABSTRACT

Improved methods and compositions for stabilizing a subterranean formation containing water sensitive minerals are provided. The formation is contacted with a water soluble stabilizing compound that dissolves to form a divalent organic cation. The stabilizing compound inhibits the swelling and migration of clays and fines, thereby alleviating loss in permeability of the formation.

### FIELD OF THE INVENTION

The present invention relates to improved methods and compositions for treating a subterranean formation in order to stabilize swelling clays and migrating fines.

### BACKGROUND OF THE INVENTION

The recovery of fluids such as oil and gas from subterranean formations has been troublesome in formations that contain water sensitive minerals, e.g., water-swellable clays such as clays in the smectite group and fines capable of migrating when disturbed such as silica, iron minerals and alkaline earth metal carbonates. The clays and fines are normally stable in the formation and do not present an obstruction to the flow of hydrocarbons. However, when the clays and fines are contacted by aqueous fluids not indigenous to the formation and in disequilibrium with the minerals in the formation, the clays can swell and/or the fines can migrate. These aqueous fluids can be injection fluids, drilling muds, stimulation fluids, and gels. The resulting swelling and migration tend to block the passageways to the well bore and cause a loss in permeability of the formation.

This loss in permeability and plugging or impairing the flow of formation fluids toward the well bore results in either a loss of the formation fluids or a decrease in the rate of recovery from the well. Sometimes the migrating fines are produced with the formation fluids and present abrasion and other problems with the above-ground equipment.

In an effort to overcome these problems, various methods have been developed for treating subterranean formations to stabilize swelling clays and migratable fines therein. For example, it has been common practice to add salts to aqueous drilling fluids. The salts adsorb to clay surfaces in a cation exchange process and can effectively reduce the swelling and/or migration of the clays. Various polymers and consolidating resins have also been used. However, in many areas, environmental regulations restrict the use of high salt concentrations and various resin and polymer compositions.

Thus, there are needs for improved and more environmentally benign methods and compositions for treating subterranean formations to prevent or reduce the swelling of clays and the migration of fines during drilling, treating and fluid recovery operations.

### SUMMARY OF THE INVENTION

By the present invention, methods of stabilizing subterranean formations containing water sensitive minerals and treating fluid compositions are provided which meet the above-described needs and overcome the deficiencies of the prior art. A method of the present invention for stabilizing a formation containing water sensitive minerals comprises the following steps. The water sensitive minerals are contacted with an effective amount of a water soluble organic stabilizing compound. The cation portion of the stabilizing compound has the general formula:

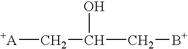

wherein A⁺ and B⁺ are selected from the group consisting of pyridinium, alkyl pyridinium, and groups having the general formula:

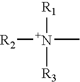

wherein R₁, R₂ and R₃ are selected from the group consisting of benzyl, alkyls having 1 to 12 carbon atoms, and alcohols having 2 to 4 carbon atoms and one hydroxyl group. The anion portion of the stabilizing compound can be basically any inorganic anion, organic anion or mixture thereof that does not adversely react with constituents of the subterranean formation.

Additionally the current invention provides treating fluid compositions for stabilizing subterranean formations containing water sensitive minerals. The compositions comprise a water soluble organic stabilizing compound, wherein the cation portion of the stabilizing compound has the general formula:

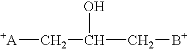

wherein A⁺ and B⁺ are selected from the group consisting of pyridinium, alkyl pyridinium, and groups having the general formula:

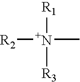

wherein R₁, R₂ and R₃ are selected from the group consisting of benzyl, alkyls having 1 to 12 carbon atoms, and alcohols having 2 to 4 carbon atoms and one hydroxyl group. The anion can be basically any inorganic anion, organic anion or mixture thereof that does not adversely react with constituents of the subterranean formation.

The objects, features and advantages of the present invention will be readily apparent to those skilled in the art upon a reading of the description of preferred embodiments with follows.

### DESCRIPTION OF THE PREFERRED EMBODIMENTS

Preferred methods of this invention for stabilizing formations containing water sensitive minerals comprise the following steps. The water sensitive minerals are contacted with an effective amount of a water soluble organic stabilizing compound. The cation portion of the stabilizing compound has the general formula:

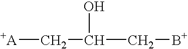

wherein A⁺ and B⁺ are selected from the group consisting of pyridinium, alkyl pyridinium, and groups having the general formula:

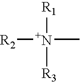

wherein R₁, R₂ and R₃ are selected from the group consisting of benzyl, alkyls having 1 to 12 carbon atoms, and alcohols having 2 to 4 carbon atoms and one hydroxyl group; and an anion. The anion can be any inorganic anion, organic anion or mixture thereof that does not adversely react with constituents of the subterranean formation.

Water sensitive minerals that can be stabilized by the methods of the present invention include fines and swellable clays. Fines stabilized by methods of the present invention include, but are not limited to, silica, iron minerals, alkaline earth metal carbonates, feldspars, biotite, illite, chlorite and mixtures thereof. Without stabilization, these fines often cause a reduction in formation permeability by migrating to the well bore and blocking pore throats and passageways to the well bore. Contacting the fines with the stabilizing compounds of this invention, reduces the tendency of the fines to migrate and therefore reduces their tendency to decrease formation permeability.

Swellable clays that can be stabilized by methods of the present invention include, but are not limited to, the smectite group such as montmorillonite, beidellite, nontronite, saponite hectorite and sauconite; the kaolin group such as kaolinite, nacrite, dickite, endellite and halloysite; the illite group such as hydrobiotite, glauconite and illite; the chlorite group such as chlorite, greenalite and chamosite; and other clay minerals not belonging to the above groups such as vermiculite, palygorskite, sepiolite; and mixed-layer (both regular and irregular) varieties of the above minerals. For example, smectite clay minerals, which have a very high cation exchange capacity, tend to swell when contacted with fresh water, thereby reducing formation permeability. The swelling can also cause smectite to disperse into platelets which can then migrate and block passageways to the well bore. Contacting swellable clays with the stabilizing compounds of this invention reduces the tendency of these clays to swell. Without being limited to any particular theory, it is believed that the cation of the stabilizing compound adsorbs to the surface of the clays and fines and prevents their swelling and migration.

Specific examples of stabilizing compound cations which are suitable for use in the present invention include, but are not limited to, 1,3-Bis(trimethylammonium)-2-hydroxy propane, 1,3-Bis(triethylammonium)-2-hydroxy propane, 1,3-Bis(dimethyl, ethylammonium)-2-hydroxy propane, 1,3-Bis(tripropylammonium)-2-hydroxy propane and combinations thereof. Preferably, the stabilizing compound cation is 1,3-Bis(trimethylammonium)-2-hydroxy propane and is represented by the following formula:

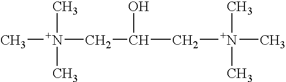

The anion portion of the stabilizing compound can be basically any inorganic ion, organic ion or mixture thereof providing they are compatible with the subterranean formation and with other treatments of the subterranean formation. Particularly suitable anions of the stabilizing compound of this invention include, but are not limited to, chloride, bromide, fluoride, iodide, nitrate, and sulfate. Preferably the stabilizing compound is 1,3-Bis(trimethylammonium chloride)-2-hydroxy propane.

A preferred method for stabilizing a formation containing water sensitive minerals comprises treating the formation with a treatment fluid comprising an effective amount of the water soluble organic stabilizing compound described above. The treatment fluid is prepared by combining and mixing a known volume or weight of treatment fluid and stabilizing compound using mixing procedures known to those skilled in the art. Preferably, the treatment fluid comprises water and stabilizing compound wherein the stabilizing compound is present in the treatment fluid in an amount in the range of from about 0.01% to about 10% by volume thereof, more preferably from about 0.5% to about 2%.

The water utilized in the treatment fluid of this invention can be fresh water or salt water depending on the density desired and the formation sensitivity. The term “salt water” is used herein to mean unsaturated salt water or saturated salt water including brines and seawater.

Additional salt may be added to the treatment fluid. Suitable salts include, but are not limited to, sodium, ammonium, potassium, calcium and zinc chlorides, bromides, hydroxides, and acetates, as well as other salts commonly used and known to those skilled in the art. Preferably salt is present in the treatment fluid in an amount in the range of from about 0.01% to about 40% by weight thereof, and more preferably from about 1% to about 10%.

The treatment fluid can also comprise aqueous acid solutions. Suitable aqueous acids include, but are not limited to, hydrochloric acid, citric acid, acetic acid, formic acid, hydrofluoric acid, and mixtures thereof. The treatment fluid can comprise alcohol-water mixtures such as methanol and water as well as gelled fluids containing various polysaccharides and synthetic polymers. As will be understood by those skilled in the art, a variety of conventional additives can be added to the treatment fluid which do not adversely react with the stabilizing compounds of this invention.

The treatment fluid can be made to contact the water sensitive minerals by any suitable method which provides effective contact between the treatment fluid and the minerals. The treatment fluid utilized can be used in conjuction with drilling, well injecting, gravel packing, fracturing or other operations performed on the subterranean formation. For example, the treatment fluid containing stabilizing compound can be used in conjunction with drilling or completion operations to alleviate the damage otherwise caused by drilling or completion fluids.

When treating the formation adjacent to the well bore, the treatment fluid can be spotted and allowed to penetrate the formation being treated. During production, recovery rates can be stimulated by injecting an effective amount of treatment fluid to penetrate the formation, and then resuming production. In a water flood oil recovery operation the treatment fluid can be injected in front of the water flood in order to stabilize the clays and fines.

Acidizing is a common technique used to improve production. Acid is pumped into the formation to enlarge passageways and improve permeability. In some formations, acidizing can loosen fines which then migrate and cause plugging. Addition of the stabilizing compound of this invention to the acid treatment fluid helps to prevent the fines from migrating thereby improving the efficiency of the acidizing step.

Hydraulic fracturing is another common technique to improve the rate of production from a well. The well is pressurized until the formation fractures. The fracturing fluid enters the fractures and deposits proppant material in the fractures. The proppant material holds the fractures open after the fracturing fluid flows back to the well. Fracturing fluid that bleeds into the formation can react with clays and fines to reduce permeability. Use of the stabilizing compound of this invention in conjunction with fracturing minimizes the swelling and migration of the clays and fines caused by contact with the fracturing fluid.

A preferred treatment fluid composition of this invention for stabilizing subterranean formations containing water sensitive minerals comprises a stabilizing compound, wherein the cation portion of the stabilizing compound has the general formula:

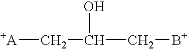

wherein A⁺ and B⁺ are selected from the group consisting of pyridinium, alkyl pyridinium, and groups having the general formula:

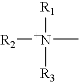

wherein R₁, R₂ and R₃ are selected from the group consisting of benzyl, alkyls having 1 to 12 carbon atoms, and alcohols having 2 to 4 carbon atoms and one hydroxyl group. The anion can be basically any inorganic anion, organic anion or mixtures thereof.

Preferably the stabilizing compound is 1,3-Bis(trimethylammonium chloride)-2-hydroxy propane and the treating fluid further comprises water. The water can be either fresh or salt water.

A preferred method of this invention for stabilizing formations containing water sensitive minerals comprises contacting the water sensitive minerals with an effective amount of a water soluble organic stabilizing compound wherein the cation portion of the stabilizing compound has the general formula:

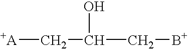

wherein A⁺ and B⁺ are selected from the group consisting of pyridinium, alkyl pyridinium, and groups having the general formula:

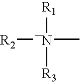

wherein R₁, R₂ and R₃ are selected from the group consisting of benzyl, alkyls having 1 to 12 carbon atoms, and alcohols having 2 to 4 carbon atoms and one hydroxyl group.

In order to further illustrate the methods and compositions of the present invention, the following examples are given.

### EXAMPLE 1

Permeability tests were performed to compare the stability provided by 1,3-Bis(trimethylammonium chloride)-2-hydroxypropane to that provided by “Cla-Sta FS™,” a clay stabilizer commercially available from Halliburton Energy Services, Inc. of Duncan, Okla. A clay-laden sand sample was prepared containing a homogeneous mixture of 88 weight percent sand with a particle size of 70-170 U.S. mesh, 10 weight percent silica flour having a particle size of 200 mesh and smaller, and 2 weight percent smectite having a particle diameter less than or equal to 50 microns.

Core samples were then prepared in a Hassler sleeve to a total length of 4 inches. The clay-laden sand was packed between other sand samples to help minimize mixing of particulate during the flow test. A gradual decrease in sand size helps distribute the flow path of fluid injected into the sand pack and prevents the occurrence of turbulence. Therefore, the sand pack was prepared of 15 g of 20-40 mesh sand, followed by 10 g of 70-170 mesh sand, followed by 60 g of clay-laden sand described above, followed by another 10 g of 70-170 mesh sand at the outlet.

The permeability tests were carried out at room temperature by injecting fluids into the sand packs at pressures less than 10 psig. Initially, a 5% KCl solution was injected into the sand packs until a stable flow rate was obtained. The sand packs were then treated with stabilizer solutions by flowing 100 mL (about 10 pore volumes) of either 1% 1,3-Bis(trimethylammonium chloride)-2-hydroxypropane or a 1% solution of “Cla-Sta FS™,” a clay stabilizer commercially available from Halliburton Energy Services, Inc. of Duncan, Okla. This was followed by 50 mL (about 5 pore volumes) of deionized water and the 5% KCl until a stable flow rate was obtained. Permeability was measured for each fluid injected. Tests for 1,3-Bis(trimethylammonium chloride)-2-hydroxypropane and for “Cla-Sta FS™” were run in duplicate. A control test was also run using no stabilizing solution flow. The permeability measurements are shown in Table 1 below.

TABLE 1
Permeability Measurements, mD

| | Control | BCH* | BCH* | Cla-Sta FS ™ | Cla-Sta FS ™ |
|---|---|---|---|---|---|
| Fluid | | Test 1 | Test 2 | Test 1 | Test 2 |
| 5% KCl | 255.2 | 369.4 | 438.6 | 446.6 | 397.8 |
| 1% | — | 412.8 | 284.8 | 388.3 | 348.4 |
| Stabilizer | | | | | |
| Deionized | 28.1 | 404.3 | 283.1 | 365.2 | 290 |
| water | | | | | |
| 5% KCl | 4 | 393 | 255.9 | 446.6 | 413 |

*BCH = 1,3-Bis(trimethylammonium chloride)-2-hydroxypropane

As can be seen from Table 1, the performance of 1,3-Bis(trimethylammonium chloride)-2-hydroxypropane is comparable to the currently commercially available clay stabilizer, “Clay-Sta FS™;” however, 1,3-Bis(trimethylammonium chloride)-2-hydroxypropane is much more environmentally acceptable.

### EXAMPLE 2

Capillary suction time (CST) tests were performed on all the fluids that were used for injection through the cores in the previous example. The CST equipment measures the time (in seconds) required for a sample fluid to pass between two electrodes and is used to determine the propensity of a clay to swell once it is introduced to fresh water. The recorded time is directly related to the sample's swelling potential, i.e., longer times equate to higher swelling potential. CST tests were run on the fluids alone, indicated as “Blank,” and on the fluids mixed with the sand pack sample previously described. Results, in Table 2 below, show that 1,3-Bis(trimethylammonium chloride)-2-hydroxypropane is superior to “Cla-Sta FS™” in its ability to inhibit the swelling of clays.

TABLE 2
CST Measurements, seconds

| | DI Water | 5% KCl | 1% BCH* | 1% Cla-Sta FS |
|---|---|---|---|---|
| Blank | 127 | 104 | 138 | 99 |
| Mixed with sand pack | 190.7 | 16.6 | 21.5 | 16.5 |
| sample | | | | |

*BCH = 1,3-Bis(trimethylammonium chloride)-2-hydroxypropane

Thus, the present invention is well adapted to carry out the objects and attain the benefits and advantages mentioned as well as those that are inherent therein. While numerous changes to the compositions and methods can be made by those skilled in the art, such changes are encompassed within the spirit of this invention as defined by the appended claims.

What is claimed is:

1. A method for stabilizing a formation containing water sensitive minerals comprising contacting said water sensitive minerals with an effective amount of a water soluble organic stabilizing compound wherein the cation portion of said stabilizing compound has the general formula: 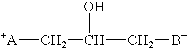
wherein A⁺ and B⁺ are selected from the group consisting of pyridinium, alkyl pyridinium and groups having the general formula: 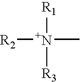
wherein R₁, R₂ and R₃ are selected from the group consisting of benzyl, alkyls having 1 to 12 carbon atoms, and alcohols having 2 to 4 carbon atoms and one hydroxyl group.

2. The method of claim 1 wherein said water sensitive minerals are fines capable of migrating and decreasing formation permeability.

3. The method of claim 2 wherein said fines are selected from the group consisting of silica, iron minerals, alkaline earth metal carbonates, feldspars, biotite, illite, chlorite and mixtures thereof.

4. The method of claim 1 wherein said water sensitive minerals are swellable clays.

5. The method of claim 4 wherein said swellable clays are selected from the group consisting of smectite, kaolin, illite, chlorite, vermiculite, palygorskite, sepiolite and mixed-layer varieties and mixtures thereof.

6. The method of claim 1 wherein said cation portion of said stabilizing compound is selected from the group consisting of 1,3-Bis(trimethylammonium)-2-hydroxy propane, 1,3-Bis(triethylammonium)-2-hydroxy propane, 1,3-Bis(dimethyl, ethylammonium)-2-hydroxy propane, 1,3-Bis(tripropylammonium)-2-hydroxy propane and combinations thereof.

7. The method of claim 1 wherein the anion portion of said stabilizing compound is selected from the group consisting of chloride, bromide, fluoride, iodide, nitrate and sulfate.

8. The method of claim 1 wherein said stabilizing compound is 1,3-Bis(trimethylammonium chloride)-2-hydroxypropane.

9. A method for stabilizing a formation containing water sensitive minerals comprising treating the formation with a treatment fluid comprising an effective amount of a water soluble organic stabilizing compound wherein the cation portion of said stabilizing compound has the general formula: 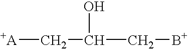
wherein A⁺ and B⁺ are selected from the group consisting of pyridinium, alkyl pyridinium and groups having the general formula: 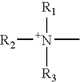
wherein R₁, R₂ and R₃ are selected from the group consisting of benzyl, alkyls having 1 to 12 carbon atoms, and alcohols having 2 to 4 carbon atoms and one hydroxyl group.

10. The method of claim 9 wherein said cation portion of said stabilizing compound is selected from the group consisting of 1,3-Bis(trimethylammonium)-2-hydroxy propane, 1,3-Bis(triethylammonium)-2-hydroxy propane, 1,3-Bis(dimethyl, ethylammonium)-2-hydroxy propane, 1,3-Bis(tripropylammonium)-2-hydroxy propane and combinations thereof.

11. The method of claim 9 wherein said stabilizing compound is 1,3-Bis(trimethylammonium chloride)-2-hydroxypropane.

12. The method of claim 9 wherein said stabilizing compound is present in said treatment fluid in an amount in the range of from about 0.01% to about 10% by volume thereof.

13. The method of claim 9 wherein said treatment fluid further comprises water.

14. The method of claim 13 wherein said water is selected from the group consisting of fresh water and salt water.

15. The method of claim 13 wherein said treatment fluid further comprises a salt wherein the cation portion of said salt is selected from the group consisting of sodium, ammonium, potassium, calcium, zinc and mixtures thereof and said salt is present in said treatment fluid in an amount in the range of from about 0.01% to about 40% by weight thereof.

16. The method of claim 13 wherein said treatment fluid further comprises an aqueous acid selected from the group consisting of hydrochloric acid, citric acid, acetic acid, formic acid, hydrofluoric acid, and mixtures thereof.

17. The method of claim 13 wherein said treatment fluid further comprises an alcohol.

18. The method of claim 13 wherein said treatment fluid further comprises a gelled fluid.

19. The method of claim 9 wherein said treating is effected during the drilling of a well bore through said formation.

20. The method of claim 9 wherein said treating is effected during production from a producing formation or injection into a formation.

21. The method of claim 9 wherein said treating is effected during fracturing or acidizing of said formation.

22. A treating fluid composition for stabilizing formations containing water sensitive minerals comprising a water soluble organic stabilizing compound wherein the cation portion of said stabilizing compound has the general formula: 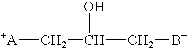
wherein A⁺ and B⁺ are selected from the group consisting of pyridinium, alkyl pyridinium, and groups having the general formula: 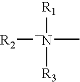
wherein R₁, R₂ and R₃ are selected from the group consisting of benzyl, alkyls having 1 to 12 carbon atoms, and alcohols having 2 to 4 carbon atoms and one hydroxyl group.

23. The treatment fluid composition of claim 22 wherein said cation in said stabilizing compound is selected from the group consisting of 1,3-Bis(trimethylammonium)-2-hydroxy propane, 1,3-Bis(triethylammonium)-2-hydroxy propane, 1,3-Bis(dimethyl, ethylammonium)-2-hydroxy propane, 1,3-Bis(tripropylammonium)-2-hydroxy propane and combinations thereof.

24. The treatment fluid composition of claim 22 wherein the anion portion of said stabilizing compound is selected from the group consisting of chloride, bromide, fluoride, iodide, nitrate and sulfate.

25. The treatment fluid composition of claim 22 wherein said stabilizing compound is 1,3-Bis(trimethylammonium chloride)-2-hydroxypropane.

26. The treatment fluid composition of claim 22 wherein said stabilizing compound is present in said composition in an amount in the range of from about 0.01 to about 10% by volume thereof.

27. The treatment fluid composition of claim 22 further comprising water wherein said water is selected from the group consisting of fresh water and salt water.

28. The treatment fluid composition of claim 27 further comprising a salt wherein the cation portion of said salt is selected from the group consisting of sodium, ammonium, potassium, calcium, zinc and mixtures thereof, and said salt is present in said treating fluid in an amount in the range of from about 0.01% to about 40% by weight thereof.

29. The treatment fluid composition of claim 27 further comprising an aqueous acid selected from the group consisting of hydrochloric acid, citric acid, acetic acid, formic acid, hydrofluoric acid, and mixtures thereof.

30. The treatment fluid composition of claim 27 further comprising an alcohol.

31. The treatment fluid composition of claim 27 further comprising a gel.
